(19) United States
(12) Patent Application Publication
(10) Pub. No.: US 2019/0213798 A1
(43) Pub. Date: Jul. 11, 2019

(54) HYBRID HAND AND FINGER MOVEMENT BLENDING TO CREATE BELIEVABLE AVATARS

(71) Applicant: Unchartedvr Inc., San Rafael, CA (US)

(72) Inventor: Douglas Griffin, Mill Valley, CA (US)

(21) Appl. No.: 16/241,579

(22) Filed: Jan. 7, 2019

Related U.S. Application Data
(60) Provisional application No. 62/614,469, filed on Jan. 7, 2018.
(60) Provisional application No. 62/614,467, filed on Jan. 7, 2018.

(51) Int. Cl. G06T 19/20; G06F 3/01; G01S 17/89; G06T 15/20; G06T 13/40; G06K 9/00

(52) U.S. Cl. CPC G06T 19/20; G06F 3/017; G01S 17/89; G06K 9/00369; G06T 13/40; G06F 3/011; G06K 9/00335; G06T 15/205

(57) ABSTRACT

A system is described for providing an enhanced virtual reality experience (VR) for players. The system includes mobile tracking systems mounted on the players' headsets, a data processor, and a plurality of VR engines. The player-mounted tracking systems produce data tracking movements of the players' arms, hands, and/or fingers. But sometimes, the players' arms, hand, and/or fingers are obscured. The data processor detects when this occurs. When it does occur, the data processor selects a predefined gesture that can most appropriately be inferred from the data. The data processor blends the selected, predefined gesture with the tracking system data to enable generation of a VR representation of the player that most appropriately represents the player. Each player wears a VR engine that uses the blended data to represent the player's self as well as other players.

### RELATED APPLICATIONS

This application claims the benefit of U.S. Provisional Patent Application No. 62/614,469, filed Jan. 7, 2018, and U.S. Provisional Patent Application No. 62/614,467, filed Jan, 7, 2018, both of which are incorporated herein by reference for all purposes.

### FIELD OF THE INVENTION

This application relates to virtual reality attractions and, more specifically, to virtual reality attractions that blend physical elements with VR representations.

### BACKGROUND

With the growth of 3D gaming, various companies have developed technology to track people and motions on a set, and then simulate the same motions on avatars created for a 3D virtual world. Leap Motion is one such technology, and there are others. These technologies suffer two significant problems: (1) erroneous global location of the hand, and (2) occlusion of the hand when engaged with a prop. There is a need for improvements in this technology that will more accurately, or at least more realistically simulate hand and finger movements and gestures, even when the hand and/or fingers are obscured from a camera's view.

### SUMMARY

In U.S. patent application Ser. No. 15/828,198, entitled “Method for Grid-Based Virtual Reality Attraction,” which was filed Dec. 7, 2017 and which I herein incorporate by reference for all purposes, I described a VR attraction that blended virtual experiences seen or heard on a headset with real, physical, tactical physical props that spatially corresponded with virtual objects seen in the virtual world. Examples of physical props included a warped wooden plank laid down on the floor, an elevator simulator on the floor that simulates but does not provide real floor-to-floor movement, and a real flashlight and flashlight beam that are virtually represented in the headset.

U.S. Provisional Patent App. No. 62/614,467, entitled “Hybrid Hand Tracking of Participants to Create Believable Digital Avatars,” was directed to improvements in the tracking of arms, hands, and fingers of a VR attraction participant (hereinafter, “participant”) so that the virtual representation that is seen through the VR headsets approximately (and convincingly) corresponds with the actual position of the participant's arms, hands, and fingers. The nonprovisional of Ser. No. 62/614,467 is being filed the same day as the instant application, and is herein incorporated by reference.

This application introduces another hybrid approach to motion tracking of the arms and hands. Predefined hand and finger poses are blended into the live-tracked hand and finger motion.

### BRIEF DESCRIPTION OF THE DRAWINGS

FIG. 1 illustrates a space with VR players with varying arm positions, wherein the VR players are equipped with headset-mounted tracking systems, and the space is equipped with a fixed motion tracking system.

FIGS. 2-6 illustrate common gestures the VR system's data processing center grafts onto an avatar's arm when the system infers that the gesture exists but the player's arm, hand, and/or fingers are obscured from view of the headset-mounted tracking system.

FIG. 7 illustrates optional sets of information that are associated with each gesture in the common gesture database of FIG. 1.

### DETAILED DESCRIPTION

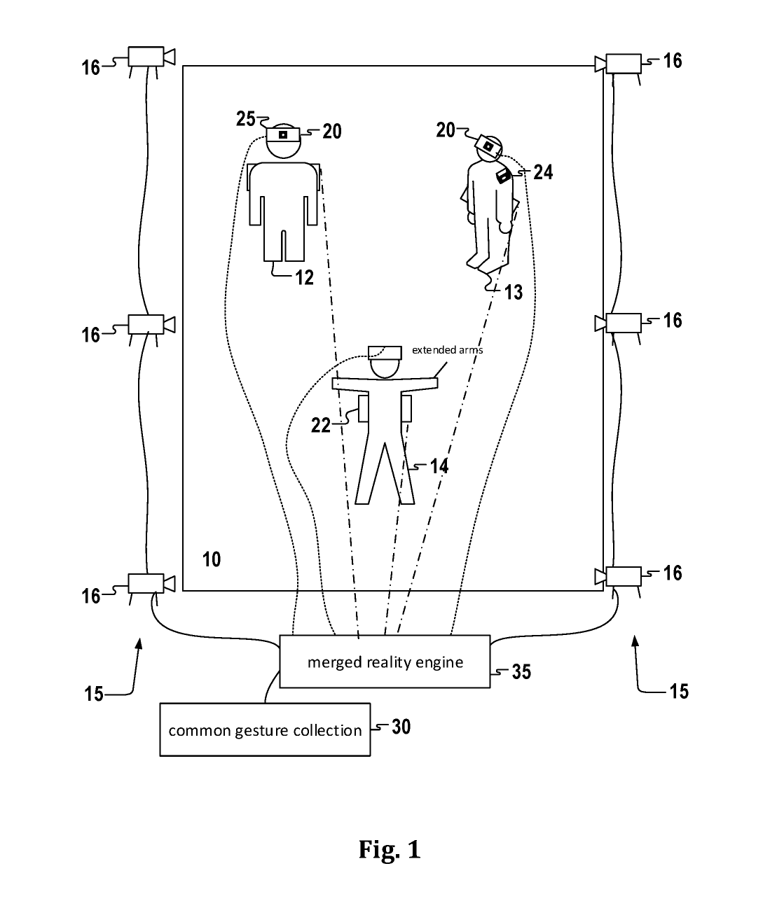

FIG. 1 illustrates a space 10 equipped and configured to provide a VR experience. The space 10 provides the underlying spatial and textural structure of a VR “world” in which players 12, 13, 14, physical objects, and props in the space 10 take on a thematic appearance. The VR experience overlays the space 10 with the visual and audio components of a VR representation of that space (hereinafter “VR world”) in which physical objects and props in the space 10 take on a visually thematic appearance supplemented by VR world audio. The players 12, 13, 14 are depicted as avatars in the VR world.

To provide the positional structure for simulating a VR experience, the VR players 12, 13, 14 are equipped with mobile motion tracking systems 25 that are mounted in backpacks, headsets, or other accoutrements worn or carried by the players 12, 13, 14. Each motion tracking system 25 comprises at least one camera, and preferably also an inertial measurement unit (such as or including a gyroscope), worn or carried by a player. Elements of the motion tracking system 25 that process image data into coordinate data can be carried out either on the person or offside. In one embodiment, the space 10 is also equipped with a fixed motion tracking system 15 comprising a plurality of cameras and/or sensors 16 positioned at least along a perimeter of the space 10, and optionally also positioned overhead.

A merged reality engine 35 is configured to coordinate the physical “world” that exists on the stage 1 with the “VR world.” The merged reality engine 35 receives and compiles the data generated by the headset-mounted tracking systems 25 and (optionally) the fixed motion tracking system 15. With this data, the merged reality engine 35 tracks where each VR player 12, 13, 14 is located and oriented within the staged physical environment, whether one of the VR player 12, 13, 14's hands is reaching out to or holding a prop in the staged physical environment, and where the VR player 12, 13, 14's head and/or eyes are pointing. The engine 35 continually updates the VR world with live video feedback and/or positional coordinates captured or derived from fixed and/or user-mounted motion capture cameras as well as other sensory feedback. The merged reality engine 35 also provides physical coordination by controlling doors, windows, fans, heaters, simulated elevators, and other smart props in the staged physical environment. The merged reality engine 35 sends the updated VR world, supplemented with signals regarding sensed conditions, VR player 12, 13, 14 and prop locations, to one or more VR engines. For example, if a VR player 12, 13, 14 moves a prop, then the merged reality engine 35 provides information to the VR engines 22 to reposition and/or reorient the corresponding virtual props to match the participant-altered location and orientation of the physical props.

In one embodiment, the mobile motion tracking system 25 comprises hardware and software associated with a Leap Motion™ system developed by Leap Motion, Inc., of San Francisco, Calif. The cameras of the mobile motion tracking system 25 are mounted in headsets 20 that are provided for the players 12, 13, 14. The mobile motion tracking systems 25 generate data regarding the players' positions within the space 10 in the form of 6-degrees-of-freedom (6DoF) coordinates that track the movement of retroreflective markers (which reflect light back to the camera with minimal scattering) worn by the players. With information about arm, hand, and finger positions integrated into the construction of a player's avatar, VR players are able to visualize their forearms, hands and fingers, as long as these appendages are visible to the Leap Motion system.

On its own, a motion tracking system such as the Leap Motion™ system can only track the forearms, hands, and fingers when the arms, hands, and fingers when they are visible to it. At times, a portion of a persons' arm or arms will be concealed from the view of the head-mounted camera. A number of positions can conceal the arms from the optical sensors' views, such as when the arms are at rest, when an arm is placed behind the back, or when an arm is reaching around a corner or holding a prop. In the prior art, this resulted in either that portion not being shown or being shown as if that portion was frozen in its last detected position. This results in tracking problems and VR artifacts. Consequently, players in a VR experience see poor, jerky, and strange arm and hand movements on each other's avatars.

One remedy to this problem is discussed in this application. Three other remedies are discussed in related U.S. Provisional Patent Application No. 62/614,467, which is incorporated by reference.

The remedy described herein is to blend a selected gesture or pose from a database or collection of gestures or poses with tracking data from the mobile motion tracking system 25 in order to complete the player's positional profile.

As noted before, the mobile motion tracking systems 25 generate data regarding the players' positions within the space 10 in the form of 6-degrees-of-freedom (6DoF) coordinates that track the movement of retroreflective markers (which reflect light back to the camera with minimal scattering) worn by the players. Image-interpreting software identifies and tracks markers in the images, including the correct global positions of the player's forearm and wrist. In one embodiment, the image-interpreting software is incorporated into the merged reality engine 35. In another, the image-interpreting software is native to the mobile motion tracking system 25, which pre-processes the video data to generate the tracking data, before it is received by the merged reality engine. The software may either share the VR server with the merged reality engine 35, reside on a separate processor, or reside in the cameras 16 themselves.

A collection 30 of common hand, finger, and arm gestures or poses is maintained. In one embodiment, a gesture is a set of positional markers that define the relative configuration of the person's arm, hand, and/or fingers. In one implementation, the positional markers are provided in a 6DoF format and—to facilitate blending of the gesture with motion tracking positional data—comprise marker data sets that are equivalent to the retroreflective marker data sets used to identify the actual configuration of a player's arm, hand, and/or fingers. In another embodiment, a gesture includes data for simulating muscle movements, skin, clothing, accoutrements, and the like within the gesture.

In one embodiment, objects such as props, doors, and light switches in the space 10 are associated with one or more selectable, predetermined gestures. For instance, a light switch may have two predetermined poses related to switching the light on or off.

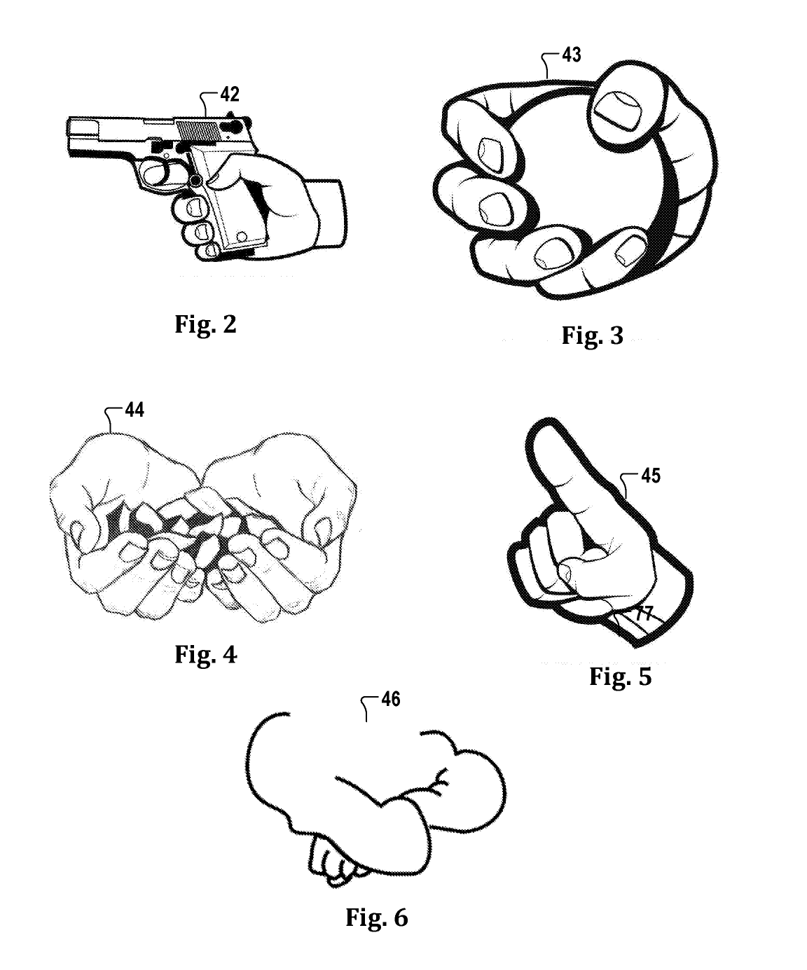

FIGS. 2-6 illustrate a sampling of gestures 42-46 that, in one embodiment, are provided by the common gesture database. When the merged reality engine 35 determines that sufficient conditions exist for blending a gesture represented in the common gesture collection 30 onto a player's avatar, the merged reality engine 35 selects the most appropriate gesture from the common gesture collection 30 and grafts it onto real-time imaging data of the player.

The merged reality engine 35, which may be embodied in a VR server (not shown), smartly blends in a selected one of these gestures or poses to complete an image of a player's avatar that is only partially represented by data from the headset-mounted and (optionally) the fixed motion tracking system(s). The merged reality engine 35 selects a gesture or pose from the collection 30 that is most consistent with the player's last visible, actual gesture or pose. The merged reality engine 35 also scales and rotates the selected gesture or pose in preparation for blending the gesture or pose (or a portion of it) with a portion of the player's limb that is (a) still visible to the mobile motion tracking system or (b) above a joint to which the selected gesture or pose is to be attached. The merged reality engine 35 also calculates a transitional set of arm, wrist, and finger movements, based on rules for those movements, to blend the VR representation of the last actual gesture or pose with the selected gesture or pose.

In another embodiment, the merged reality engine 35 is programmed to replace a player's actual gesture or pose, as represented by retroreflective tracking data, with a selected gesture or pose.

By smartly blending in common contextually relevant poses, the VR image produced by the merged reality engine 35 generates a natural-looking transition from live-data (from Leap Motion) to pre-recorded arm, hand, and finger poses. In one embodiment, the merged reality engine 35 does this for a large set of conditions, such as the following: grabbing a doorknob, holding a prop such as a gun prop, grabbing a VR headset, crossing or folding arms, and holding one's hands together. FIGS. 2-6 illustrate another set of conditions, providing gestural templates for an avatar holding a firearm, a ball, rocks or coal or treasure, and also for a hand pointing using the index finger and crossed or folded arms.

In one embodiment, the merged reality engine 35 detects on a player-by-player basis whether headset-mounted-tracking-system-generated data does not represent all of the markers on a player's arm, hand and/or fingers, and if so, selects a gesture to blend or graft into the player's avatar. Alternatively, the merged reality engine 35 also evaluates headset-mounted-tracking-system-generated raw image date for completeness and ambiguity. In either case, if the marker data or the information the merged reality engine 35 can derive from the image data is ambiguous and fails to completely or confidently represent the position of the player's arms, then the merged reality engine 35 selects a gesture from the common gesture collection 30 that is most consistent with the partial or ambiguous tracking and/or imaging data and uses the selected gesture construct to build a VR arm, hand, and/or fingers for the player's avatar. This can occur when, for example, the retroreflective markers worn on a player's arms, hands, and/or fingers are obscured.

In one implementation, the above determination is based on a decision tree. At one branch, the merged reality engine 35 determines whether the player is interacting or about to interact with an object or prop in the space 10. At another branch, using a high frame rate feed (e.g., 180 fps), the merged reality engine 35 analyzes the real time orientation of the hand as it approaches an object to predict whether the player will interact with the object. For instance, if a player reaches for a drinking glass, the merged reality engine 35 detects whether the palm is vertical, and if so, selects a gesture or pose of a hand grabbing the glass from the side. Alternatively, if a player reaches for a drinking glass with the palm down, the merged reality engine 35 selects a gesture or pose that grabs the glass from above. Similarly, if a player uses their hand to interact with another player's hand the merged reality engine 35 determines whether it is a “fist bump” (palm horizontal), “hand shake” (palm vertical—thumb up), or “high five” (palm vertical—thumb pointing across guest). At yet another branch, inertial measurement unit (IMU) data collected the player's forearm signals the speed of the player's forearm movements, which is then used to select an appropriate gesture or pose.

In another implementation, the above determination is based at least in part on one or more preset, empirically-derived thresholds. In a further implementation, the merged reality processor performs a pattern recognition analysis on the image data to ascertain whether 3-D positions of person's arms, hands, and fingers are determinable from the image data.

In one implementation, the merged reality engine 35 gives confidence ratings to the tracked markers. If the confidence levels drop below a threshold, then for the corresponding player the merged reality processor 35 selects the data generated by the fixed motion tracking system 15 in place of the tracking data generated by the headset-mounted tracking system to determine the position of the corresponding player's body parts represented by the non-captured or ambiguously captured markers.

For situations when the hands are not visible and the VR engine is unable to determine which gesture to use, one embodiment of the system provides pre-recorded subtle natural movements of the hands and/or fingers, making them appear more lively.

In one embodiment, the merged reality engine 35 is configured to select and blend in gestures on the basis of the player's or the collective players' context (e.g., defensive, overpowering or celebratory) in the VR world. In one implementation, the merged reality engine 35 is configured to “infer,” based on a probability computation using collected empirical data, which gesture is most likely to resemble the player's actual hand gesture.

The merged reality engine 35 uses the merged coordinates derived from the motion tracking system and gestural template as a rough framework (or skeleton) for depicting the player's avatar. Data defining the player's selected avatar is then used to fully illustrate the avatar, using the rough framework as a foundation for illustrating the visible aspects of the avatar, and filling in the details (e.g., look and apparent texture of the skin, clothing, and any accoutrements) using other data (e.g., aesthetic and surface data) stored in the gestural template. The finished data-blended avatar representation is shared with other players.

As depicted by the dotted lines of FIG. 1, the headset-mounted tracking systems wirelessly transmit their data to the merged reality engine 35. As depicted by the solid lines, the fixed motion tracking system transmits its data to the merged reality engine 35 via signal lines connecting the merged reality engine 35 to the fixed motion tracking system. As depicted by the dash-dot lines, the merged reality engine 35 wirelessly transmits its compiled data to each player, and more particularly, to a backpack-mounted VR engine worn by each player. Each player's VR engine then uses the compiled data to generate VR images that realistically depict the corresponding avatar's arms in positions that correspond to the actual positions of the player's arms.

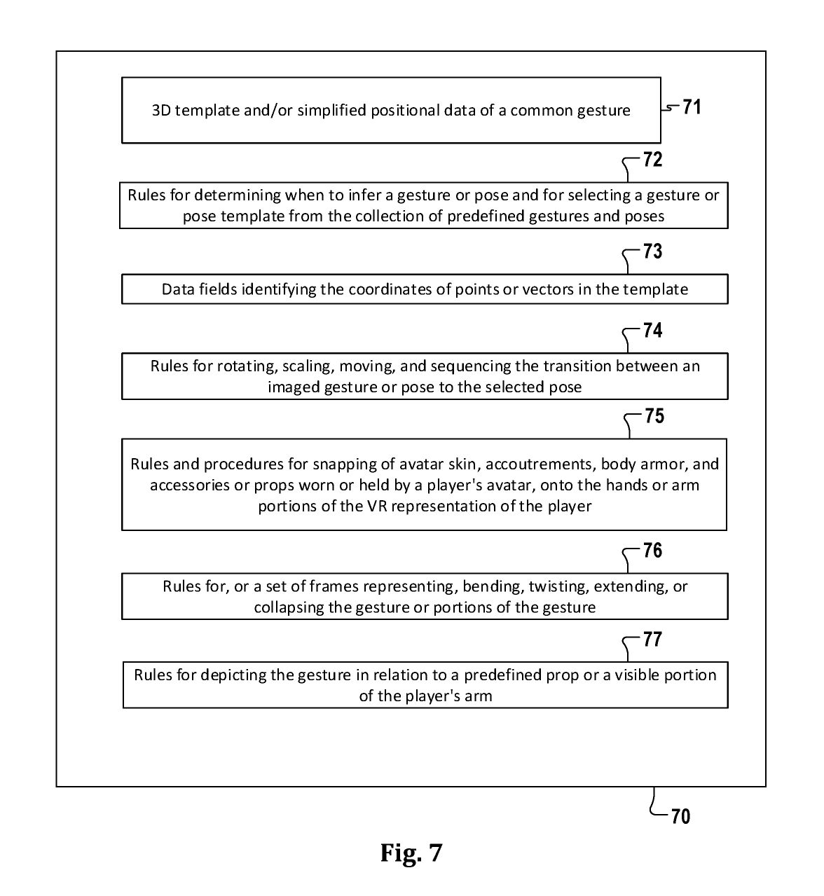

FIG. 7 illustrates a gestural construct 70 that is held inside the common gesture collection 30 of FIG. 1. At its most basic level, the gestural constructs hold a template 71 of a common gesture. The template 71 comprises a plurality of scalable and rotatable 3D coordinates that define a surface of a hand or portion of the arm formed into a gesture. In one embodiment, only a simplified set of coordinates are used corresponding to the joints and/or bones of the arm, hands, and/or fingers. In a more developed embodiment, a one-to-one correspondence is maintained between the simplified set of coordinates and the retroreflective marks worn by a player on or adjacent the player's bones or joints. This one-to-one correspondence facilitates the blending of these coordinates.

In another embodiment, the gestural template includes coordinates are of a point cloud or mesh of the gesture that not only defines the flexion of the joints but also the texture of the skin, clothing, accoutrement (e.g., a ring or glove), or other surface of the arm, hand, and/or fingers. This may be in place of, or in addition to, the retroreflective-marker-corresponding set of coordinates described in the above paragraph. In yet another embodiment, the coordinates include angular coordinates and scalable vectors. Much of this information is stored in data fields 73 identifying the coordinates of points or vectors in the template 71.

The construct 70 includes rules 72 for determining when to infer a gesture or pose and for selecting a gesture or pose template from the collection of predefined gestures and poses. The construct 70 preferably also includes rules 74 for rotating, scaling, moving, and sequencing movements of the gesture. This includes rules 74 for properly aligning the gesture with the player's arm. The construct 70 optionally also includes rules and procedures 75 for snapping of avatar skin, avatar clothing and body armor, and accessories or props worn or held by a player's avatar, onto the hand or arm portion in the VR representation of the player. In one embodiment, the construct 70 also provides rules 76 for, or a set of frames representing, the movement, bending, twisting, evolving, extending, collapsing of the gesture or portions of the gesture. In another embodiment, the construct 70 provides rules 77 for depicting the gesture in relation to a predefined prop or a visible portion of the player's arm, hand, and/or fingers.

In closing, it will be understood that the described “tracking” systems encompasses both “outside-in” systems, such as systems employed by Oculus and Vive, and “inside-out” systems using SLAM—Simultaneous Localization And Mapping—that are anticipated to be common on many headsets in the years to come. More narrow characterizations for the described “tracking” systems include “motion capture” systems and “optical motion capture” systems. Also, the innovations described herein are, in one embodiment, combined with the innovations of U.S. patent application Ser. No. 62/614,467, filed Jan. 7, 2018, which is herein incorporated by reference.

I claim:

1. A system for generating an enhanced virtual reality experience (VR) for a plurality of players, the system comprising:
for each player, a motion tracking system that is at least partially mounted on the player's head that tracks movements of the player's arms, hands, and fingers;
wherein the motion tracking system generates tracking data of at least one of the person's arms, hands, and/or fingers when visible to the mounted tracking system;
a collection of gestural templates comprising a plurality of adjustable and scalable coordinates that define a configuration of a hand formed into a gesture;
a data processor that, when a player's arm, hand, and/or fingers are obscured from the motion tracking system, selects a gestural template that represents a gesture to blend with an at least partial representation of the player's arm generated by the motion tracking system;
wherein the data processor merges the head-mounted tracking system's tracking data with at least a portion of the gesture represented by the selected gestural template, the gesture being substituted for obscured portions of the player's arm, hand, and/or fingers;
wherein the system generates a VR representation of the player that blends data from the player's tracking system with coordinates from the gestural template.

2. The system of claim 1, further comprising VR engines wearable by the players, each VR engine generating a VR representation, specific to the player wearing the VR engine, of the player's hands, wherein the VR representation is developed from positional coordinates blended from the motion tracking system and selected gestural template.

3. The system of claim 1, further comprising a plurality of retroreflective markers worn by each player, wherein:
the head-mounted tracking system is configured to identify the retroreflective markers in image data captured by the head-mounted tracking system and generate coordinate data for the retroreflective markers, with respect to retroreflective markers that are within a visual range of the head-mounted tracking system;
the collection of common gestural templates stores coordinate data for positional points of the gesture that correspond with retroreflective markers worn by a player on the player's arm, hand, and/or fingers; and
the data processor is configured to merge the retroreflective marker coordinate data with the gestural template coordinate data to provide a framework for illustrating an avatar for the player.

4. The system of claim 1, wherein the data processor detects whether the head-mounted tracking system's view of the arms, hands, and/or fingers is obscured.

5. The system of claim 4, wherein the data processor probabilistically determines, on the basis of empirical evidence, which gesture in the collection of common gesture templates most likely represents the positions of the players' obscured arms, hands, and/or fingers.

6. The system of claim 1, wherein each gestural construct comprises a plurality of scalable coordinates that define a surface of a hand formed into a gesture.

7. The system of claim 6, wherein the collection of common gesture templates includes rules for detecting whether a gesture needs to be grafted onto an arm, hand, or fingers, and when a gesture is needed, inferring which gesture is to be used.

8. The system of claim 7, wherein the collection of common gesture templates further comprises rules for selecting, scaling, and/or sequencing movements of the gesture.

9. The system of claim 8, wherein the collection of common gesture templates provides data fields associated with the coordinates that facilitate grafting a common arm, hand, and/or finger(s) gesture onto a VR image of the player.

10. The system of claim 9, wherein the collection of common gesture templates further comprises rules for placement of avatar skin, avatar clothing and body armor, and accessories or props worn or held by a player's avatar, onto the VR image of the player.

11. The system of claim 10, wherein the collection of common gesture templates includes rules for creating, bending, extending, or eliminating the gesture.

12. The system of claim 11, further comprising rules for depicting the gesture in relation to a predefined prop or a visible portion of the player's arm.

13. A method for generating an enhanced virtual reality experience for a plurality of players, the method comprising:
mounting on each player's head at least a camera of a motion tracking system that tracks movements of the player's arms, hands, and fingers;
the motion tracking system generating tracking data of at least one of the person's arms, hands, and/or fingers when visible to the motion tracking system;
detecting when at least a portion of an arm, hand, and/or fingers are obscured;
if a portion of an arm, hand, and/or fingers are obscured, then:
selecting a gestural template from a stored collection of gestural templates that provide representations of different gestures;
blending the gestural template with an at least partial representation of the player's arm generated by the motion tracking system, the selected portions filling in for portions of the arm, hand, and/or fingers that were obscured; and
generating a VR representation of the player from the blended data.

14. The method of claim 13, wherein the selected gestural construct comprises data that defines a characteristic surface of the gesture.

15. The method of claim 13, wherein the step of selecting a gestural template comprises probabilistic calculations to identify a gesture that most likely approximately represents the actual configuration of the player's arm, hand, and/or fingers.

16. The method of claim 15, further comprising scaling the coordinates of the gestural templates to render the gesture in a size that consistent in scale with the player's avatar.

17. The method of claim 15, further comprising sequencing movements of the gesture from genesis to dissolution, using rules associated with the gestural template.

18. A method for generating an enhanced virtual reality experience for a plurality of players, the method comprising:
mounting on each player's head at least a camera of a motion tracking system that tracks movements of the player's arms, hands, and fingers;
each player wearing a plurality of retroreflective markers;
the motion tracking system capturing images of the player's arm, hand, and/or fingers;
the motion tracking system identifying retroreflective markers in the captured images that are within a visual range of the head-mounted tracking system;
generating coordinate data for the retroreflective markers in the captured images;
detecting when at least a portion of an arm, hand, and/or fingers are obscured;
if a portion of an arm, hand, and/or fingers are obscured, then:
selecting a gestural template comprising a plurality of adjustable and scalable coordinates that define a configuration of a hand formed into a gesture;
wherein the coordinates correspond with retroreflective markers worn by a player on the player's arm, hand, and/or fingers;
the data processor merging the retroreflective marker coordinate data with the gestural template coordinate data to provide a framework for illustrating an avatar for the player; and
generating a VR representation of the player from the blended data.

19. The method of claim 18, wherein the step of generating a VR representation of the player from the blended data comprises:
using the blended data as a skeletal foundation; and
simulating visible aspects of the avatar using aesthetic and surface data stored in the gestural template.

20. The method of claim 18, further comprising illustrating the VR representation of the player's avatar both to the player and to other players in the VR experience.
